(19) United States
(12) Patent Application Publication
(10) Pub. No.: US 2015/0138345 A1
(43) Pub. Date: May 21, 2015

(54) ELECTRONIC DEVICE AND VIDEO OBJECT TRACKING METHOD THEREOF

(71) Applicant: INSTITUTE FOR INFORMATION INDUSTRY, Taipei (TW)

(72) Inventors: Chia-Wei LIAO, Taipei City (TW); Kai-Hsuan CHAN, Keelung City (TW)

(73) Assignee: INSTITUTE FOR INFORMATION INDUSTRY, Taipei (TW)

(21) Appl. No.: 14/092,708

(22) Filed: Nov. 27, 2013

(30) Foreign Application Priority Data
Nov. 15, 2013 (TW) 102141546

(51) Int. Cl. G06K 9/00; H04N 7/18

(52) U.S. Cl. CPC G06K 9/00624; H04N 7/18
USPC 348/135

(57) ABSTRACT

An electronic device and a video object tracking method are provided. The electronic device includes a video providing unit and a processing unit. The video providing unit is configured to provide a video. The process unit is configured to: extract a video segment of the video which includes a plurality of successive frames; define a position of at least one first object in a first frame of the successive frames; define a position of the at least one first object in a second frame of the successive frames; and determine the position of the at least one first object in each frame appearing between the first frame and the second frame according to the positions of the at least one first object in the first frame and the second frame.

### PRIORITY

This application claims priority to Taiwan Patent Application No. 102141546 filed on Nov. 15, 2013, which is hereby incorporated by reference in its entirety.

### FIELD

The present invention relates to an electronic device and a video processing method thereof. More particularly, the present invention relates to an electronic device and a video object tracking method thereof.

### BACKGROUND

In recent years, video processing functions have been widely provided in various electronic devices such as television (TV) sets, computers, mobile phones, cameras, video cameras and the like. For example, these electronic devices can generally be used to capture a video, play a video, edit a video and so on.

In some applications, a video object tracking function may increase the added value of an electronic device. For example, in a case of an interactive video, an electronic device having the video object tracking function can estimate a position of an object appearing in each frame of the video so as to embed particular information or a particular link into the object appearing in each of the frames. In this way, when the video is viewed by a user, the user can obtain the particular information or link corresponding to the object by clicking the object appearing in the video directly. In such an application, the electronic device with the video object tracking function can not only save the time of additionally searching the internet, but also facilitate the commodity promotions and event marketing of the manufacturers.

A key factor of the video object tracking technology is how to quickly estimate a motion trajectory of an object in the video, that is, how to quickly estimate variation of the object in the video (which comprises variation in size and position of the object). With advancement of various automatic estimating algorithms, the time that conventional automatic video object tracking technologies take in estimating a motion trajectory of a single object has been gradually reduced. However, conventional automatic video object tracking technologies are not reliable enough as applied to estimate moving trajectories of a plurality of objects so that manually intervention is necessary. Unfortunately, when motion trajectories of a plurality of objects need to be estimated in the video, conventional manual video object tracking technologies have to estimate the moving trajectories of different objects in the video one by one because people can only focus on one object at a time. Consequently, the time to manually track a plurality of objects tends to increase linearly. In other words, when motion trajectories of a plurality of objects need to be estimated in the video, conventional manual video object tracking technologies are not so efficient.

Accordingly, an urgent need exists in the art to provide a solution capable of reducing the time that conventional manual video object tracking technologies takes in tracking a plurality of objects.

### SUMMARY

One primary objective of certain embodiments of the present invention is to reduce the time that conventional manual video object tracking technologies take in tracking a plurality of objects.

To achieve the aforesaid objective, certain embodiments of the present invention provide an electronic device. The electronic device comprises a video providing unit and a processing unit electrically connected to each other. The video providing unit is configured to provide a video. The processing unit is configured to: extract a video segment of the video, wherein the video segment comprises a plurality of successive frames; define a position of at least one first object in a first frame of the successive frames; define a position of the at least one first object in a second frame of the successive frames; and determine a position of the at least one first object in each frame appearing between the first frame and the second frame according to the positions of the at least one first object in the first frame and the second frame.

To achieve the aforesaid objective, certain embodiments of the present invention provide a video object tracking method for use in an electronic device. The electronic device comprises a video providing unit and a processing unit electrically connected to each other. The video object tracking method comprises the steps of:

(a) providing a video by the video providing unit;

(b) extracting a video segment of the video by the processing unit, wherein the video segment comprises a plurality of successive frames;

(c) defining a position of at least one first object in a first frame of the successive frames by the processing unit;

(d) defining a position of the at least one first object in a second frame of the successive frames by the processing unit; and

(e) determining a position of the at least one first object in each frame appearing between the first frame and the second frame by the processing unit according to the positions of the at least one first object in the first frame and the second frame.

Specifically, certain embodiments of the present invention provide an electronic device and a video object tracking method thereof. With the aforesaid operations of the video providing unit and the processing unit, the electronic device and the video object tracking method thereof select two frames from a plurality of successive frames comprised in a video segment and define positions of one or more same objects in the two frames respectively. Then, a position of the one or more same objects in each frame appearing between the two frames is determined according to the positions of the one or more same objects in the two frames so as to estimate a motion trajectory of the one or more same objects between the two frames. Different from conventional manual video object tracking methods which have to estimate the motion trajectories of different objects one by one, the present invention can estimate motion trajectories of multiple objects synchronously. Therefore, the time that conventional manual video object tracking technologies takes in tracking a plurality of objects can be effectively reduced.

The detailed technology and preferred embodiments implemented for the subject invention are described in the following paragraphs accompanying the appended drawings for persons skilled in this art to well appreciate the features of the claimed invention.

### BRIEF DESCRIPTION OF THE DRAWINGS

FIG. 1 is a schematic structural view of an electronic device 1 according to a first embodiment of the present invention;

FIG. 2 is a schematic view of a video segment 22 according to the first embodiment of the present invention;

FIG. 3 is a schematic view illustrating operations of an object tracking module 135 according to the first embodiment of the present invention; and

FIG. 4 is a schematic view of a video object tracking method according to a second embodiment of the present invention.

### DETAILED DESCRIPTION

In the following description, the present invention will be explained with reference to example embodiments thereof. However, these example embodiments are not intended to limit the present invention to any specific examples, embodiments, environment, applications or particular implementations described in these embodiments. Therefore, the description of these example embodiments is only for the purpose of illustration rather than limitation. In the following embodiments and attached drawings, elements unrelated to the present invention are omitted from the depiction; and dimensional relationships among the individual elements in the attached drawings are illustrated only for the ease of understanding, but not to limit the actual scale.

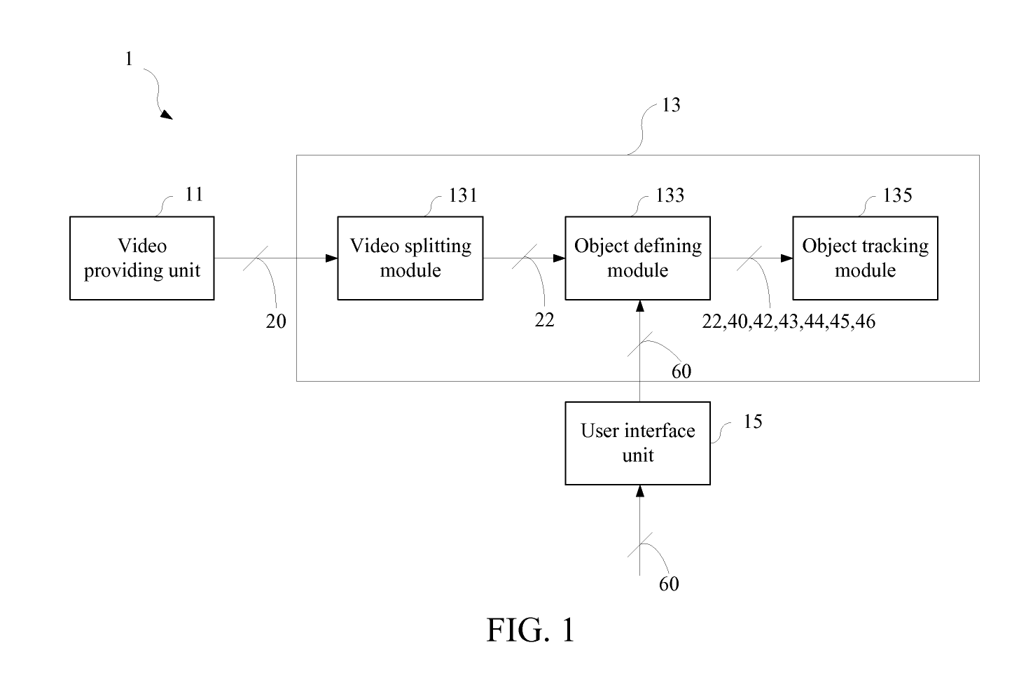

A first embodiment of the present invention is an electronic device. A schematic structural view of the electronic device is shown in FIG. 1. As shown in FIG. 1, the electronic device 1 comprises a video providing unit 11, a processing unit 13 and, optionally, a user interface unit 15. Examples of the electronic device 1 may include but are not limited to: a television, a computer, a mobile phone, a camera, a video camera and the like. The video providing unit 11 and the user interface unit 15 are both electrically connected to the processing unit 13, and the units can communicate with and transmit messages to/from each other.

The video providing unit 11 may comprise a video capturing device (e.g., a video camera), which is configured to capture a video 20 and provide the video 20 to the processing unit 13. The video providing unit 11 may also comprise a storage, which is configured to store the video 20 and provide the video 20 to the processing unit 13. In other embodiments, the video providing unit 11 may also provide the video 20 to the processing unit 13 in other ways.

The processing unit 13 is configured to extract a video segment 22 of the video 20. The video segment 22 may comprise a plurality of successive frames. The processing unit 13 is further configured to define a position 40 of at least one first object in a first frame of the successive frames and define a position 42 of the at least one first object in a second frame of the successive frames. The at least one object described in this embodiment may be considered as one or more objects. The processing unit 13 is further configured to determine a position of the at least one first object in each frame appearing between the first frame and the second frame according to the positions 40, 42 of the at least one first object in the first frame and the second frame respectively so as to estimate a motion trajectory of the at least one first object from the first frame to the second frame.

For the purpose of illustration, the processing unit 13 of this embodiment may comprise a video splitting module 131, an object defining module 133 and an object tracking module 135. In other embodiments, the processing unit 13 may be only a single processor that executes operations corresponding to the respective modules described above.

As shown in FIG. 1, after the video providing unit 11 provides the video 20 to the processing unit 13, the processing unit 13 firstly extracts the video segment 22 of the video 20 via the video splitting module 131. The video splitting module 131 is used to ensure that there is at least one common object in the plurality of successive frames comprised in the video segment 22 extracted. Therefore, the video segment 22 may be either the entire video 20 or any segment thereof.

For example, the video splitting module 131 may determine whether the frames are successive according to whether the lens for capturing the video 20 switches. If the frames are not successive, then the video splitting module 131 splits the video 20 and extracts the video segment 22 which comprises a plurality of successive frames. In other embodiments, the processing unit 13 may not comprise the video splitting module 131 and the video providing unit 11 transmits the video 20 directly to the object defining module 133.

In a case where the electronic device 1 does not comprise the user interface unit 15, the object defining module 133 of the processing unit 13 may be configured to define the position 40 of the at least one first object in the first frame of the successive frames and define the position 42 of the at least one first object in the second frame of the successive frames after the video segment 22 of the video 20 is extracted by the video splitting module 131 of the processing unit 13.

In a case where the electronic device 1 comprises the user interface unit 15, the object defining module 133 of the processing unit 13 may define the positions 40, 42 of the at least one first object in the first frame and the second frame respectively according to a user input 60 from the user interface unit 15. For example, a user may box the at least one object manually in the first frame and the second frame by means of a touch screen, a mouse, a keyboard or any of various input devices (not shown). Then, the user interface unit 15 generates the user input 60 according to the range boxed by the user in the first frame and the second frame. Then, the object defining module 133 of the processing unit 13 determines the positions 40, 42 of the at least one object in the first frame and the second frame respectively according to the user input 60.

After the positions 40, 42 of the at least one object in the first frame and the second frame are respectively defined by the object defining module 133 of the processing unit 13, the object tracking module 135 of the processing unit 13 can determine a position of the at least one first object in each frame appearing between the first frame and the second frame according to the positions 40, 42 of the at least one first object in the first frame and the second frame so as to estimate the motion trajectory of the at least one first object from the first frame to the second frame.

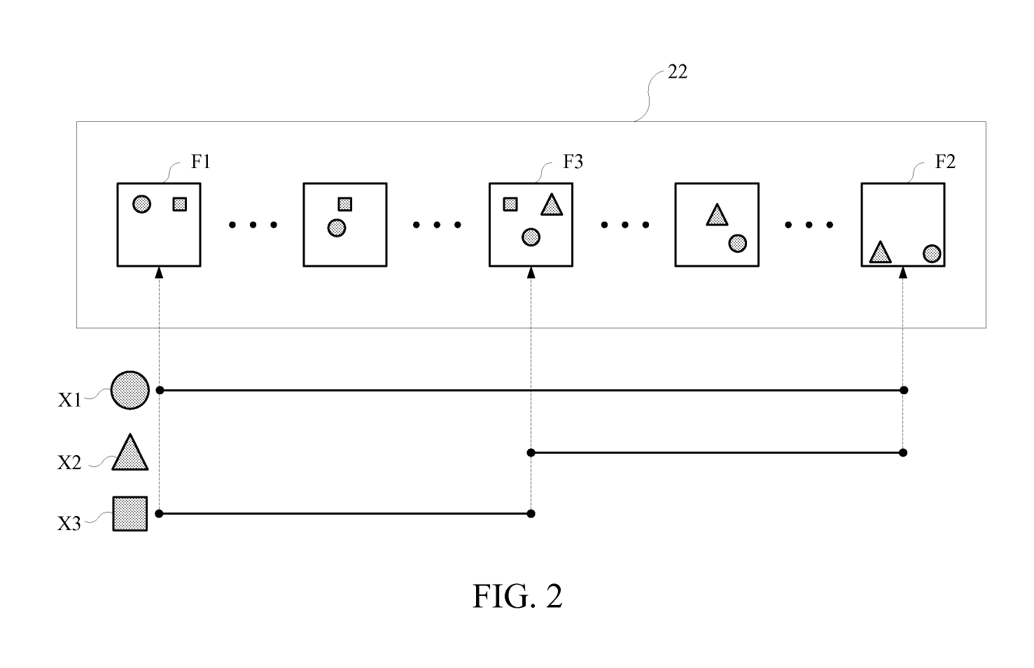

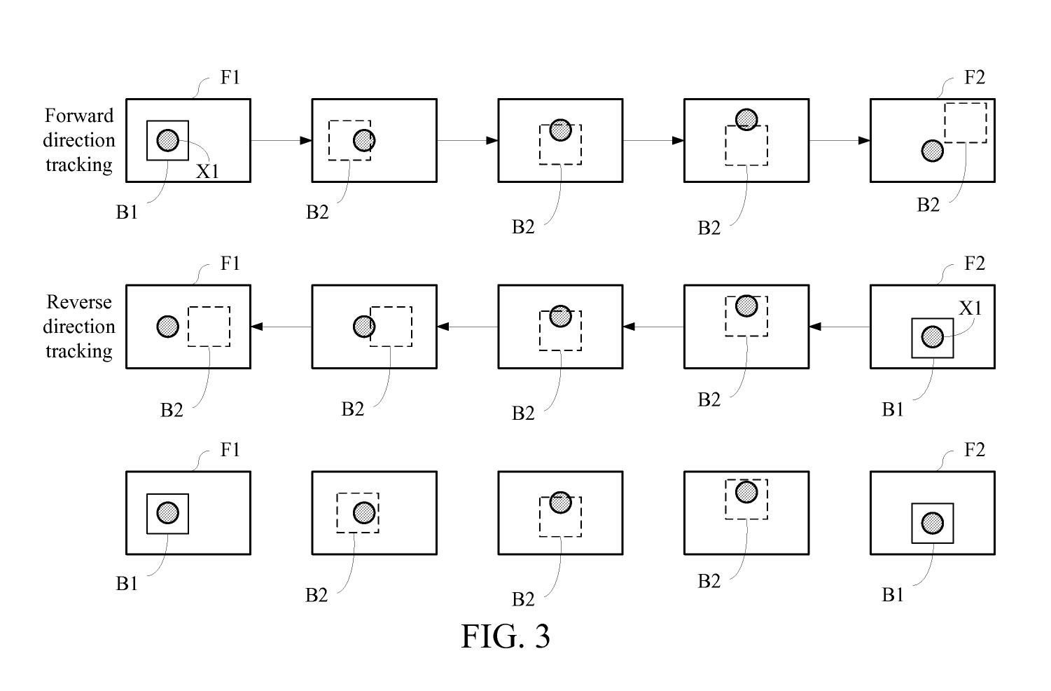

The aforesaid operations of the object defining module 133 and the object tracking module 135 will be further described hereinafter with reference to FIG. 2 and FIG. 3 as an example. FIG. 2 is a schematic view of the video segment 22, and FIG. 3 is a schematic view illustrating operations of the object tracking module 135.

As shown in FIG. 2, the video segment 22 comprises a plurality of successive frames. For the purpose of illustration, assume that the first frame F1 is a start frame of the successive frames comprised in the video segment 22, and the second frame F2 is an end frame of the successive frames comprised in the video segment 22. In other embodiments, the first frame F1 and the second frame F2 may also be any two non-adjacent frames among the successive frames comprised in the video segment 22.

The object defining module 133 of the processing unit 13 firstly determines whether a same object appears in both the first frame F1 and the second frame F2. Since a first object X1 (which is a circular-shaped object) appears in both the first frame F1 and the second frame F2, the object defining module 133 of the processing unit 13 defines the positions 40, 42 of the first object X1 in the first frame F1 and the second frame F2 respectively. Then, the object tracking module 135 of the processing unit 13 determines a position of the first object X1 in each frame appearing between the first frame F1 and the second frame F2 according to the positions 40, 42 of the first object X1 in the first frame F1 and the second frame F2.

If a plurality of first objects X1 appears in both the first frame F1 and the second frame F2, then the object defining module 133 of the processing unit 13 can define a plurality of positions 40 of the first objects X1 in the first frame F1 and a plurality of positions 42 of the first objects X1 in the second frame F2 synchronously. The object tracking module 135 of the processing unit 13 determines a position of each of the first objects X1 in each frame appearing between the first frame F1 and the second frame F2 according to the positions 40, 42 of the first objects X1 in the first frame F1 and the second frame F2 respectively.

In other embodiments, even when the frames are successive in the video segment 22, some objects may not appear in the first frame F1 but appear in the second frame F2; or some objects may appear in the first frame F1 but not appear in the second frame F2. An example of the former case is a second object X2 (which is a triangle-shaped object) shown in FIG. 2, and an example of the latter case is a third object X3 (which is a square-shaped object) shown in FIG. 2. There may be one or more second objects X2 and one or more third objects X3.

Since the second object X2 appears only in the second frame F2 but not in the first frame F1, the second object X2 may start to appear in a certain frame between the first frame F1 and the second frame F2 and remain appearing until the second frame F2. Therefore, the object defining module 133 of the processing unit 13 further defines a position 43 of the second object X2 in the second frame F2; and selects a third frame F3 from the frames between the first frame F1 and the second frame F2 and then defines a position 44 of the second object X2 in the third frame F3. Then, the object tracking module 135 of the processing unit 13 further determines a position of the second object X2 in each frame appearing between the second frame F2 and the third frame F3 according to the positions 43, 44 of the second object X2 in the second frame F2 and the third frame F3 respectively so as to estimate a motion trajectory of the second object X2 from the third frame F3 to the second frame F2.

Similarly, since the third object X3 appears only in the first frame F1 but not in the second frame F2, the third object X3 may disappear from a certain frame between the first frame F1 and the second frame F2 and remain disappearing until the second frame F2. Therefore, the object defining module 133 of the processing unit 13 further defines a position 45 of the third object X3 in the first frame F1; and selects a third frame F3 from the frames between the first frame F1 and the second frame F2 and then defines a position 46 of the third object X3 in the third frame F3. Then, the object tracking module 135 of the processing unit 13 further determines a position of the third object X3 in each frame appearing between the first frame F1 and the third frame F3 according to the positions 45, 46 of the third object X3 in the first frame F1 and the third frame F3 respectively so as to estimate a motion trajectory of the third object X3 from the first frame F1 to the third frame F3.

When the second object X2 and the third object X3 appear simultaneously, the object defining module 133 of the processing unit 13 may select two different third frames F3 from the frames between the first frame F1 and the second frame F2 to define the position 44 of the second object X2 and the position 46 of the third object X3 respectively. Alternatively, the object defining module 133 may also select only one and the same third frame F3 to define the position 44 of the second object X2 and the position 46 of the third object X3. Additionally, the third frame(s) F3 may be selected from the frames between the first frame F1 and the second frame F2 by following an empirical rule, a dichotomy rule or other conventional rules. For example, the object defining module 133 of the processing unit 13 may adopt the dichotomy method to select a middle frame between the first frame F1 and the second frame F2 as the third frame F3. In other embodiments, the third frame F3 may also be selected by the user from the frames between the first frame F1 and the second frame F2 via the user interface unit 15.

In addition to the above cases described with respect to the second object X2 and the third object X3, some objects may start to appear in a frame between the first frame F1 and the second frame F2 and disappear also in another frame between the first frame F1 and the second frame F2. In other words, these objects appear neither in the first frame F1 nor in the second frame F2. However, based on the aforesaid disclosure, the object defining module 133 and the object tracking module 135 of the processing unit 13 can still estimate the motion trajectories of such objects effectively.

For example, assume that the object defining module 133 of the processing unit 13 defines a fourth object (not shown) in the third frame F3 and the fourth object appears neither in the first frame F1 nor in the second frame F2. In this case, the object defining module 133 of the processing unit 13 may select a fourth frame (not shown) among the frames between the first frame F1 and the third frame F3, or select a fifth frame (not shown) from the frames between the third frame F3 and the second frame F2. Subsequently, the object defining module 133 defines a position of the fourth object in the fourth frame and/or the fifth frame. Similarly, the object tracking module 135 of the processing unit 13 can determine a position of the fourth object in each frame appearing between the fourth frame and the third frame F3 according to the positions of the fourth object in the fourth frame and the third frame F3 so as to estimate a motion trajectory of the fourth object from the fourth frame to the third frame F3. Alternatively, the object tracking module 135 of the processing unit 13 can determine a position of the fourth object in each frame appearing between the third frame F3 and the fifth frame according to the positions of the fourth object in the third frame F3 and the fifth frame so as to estimate a motion trajectory of the fourth object from the third frame F3 to the fifth frame.

In other embodiments, the object defining module 133 of the processing unit 13 may also determine a plurality of particular frames (not shown) between the first frame F1 and the second frame F2. For example, the object defining module 133 may determine a particular frame every N frames (where N is a positive integer) from the first frame F1 to the second frame F2 at equal intervals. Alternatively, the object defining module 133 may also determine the particular frames randomly between the first frame F1 and the second frame F2. After the particular frames are determined, the object defining module 133 may define positions of a same object in two adjacent frames. The two adjacent frames are from the first frame F1, the second frame F2, and the particular frames. Then, the object tracking module 135 of the processing unit 13 can determine a position of the same object in each frame appearing between the two adjacent frames according to the positions of the same object in the two adjacent frames.

After one or more objects are defined by the object defining module 133 of the processing unit 13 in any two non-adjacent frames of the video segment 22, the object tracking module 135 of the processing unit 13 can estimate motion trajectories of the one or more objects in the two non-adjacent frames according to various conventional video object tracking methods. As shown in FIG. 3, the object tracking module 135 of the processing unit 13 may estimate a motion trajectory of the first object X1 from the first frame F1 to the second frame F2 by using a bidirectional tracking technology (which comprises forward direction tracking and reverse direction tracking).

Assuming that there are three frames between the first frame F1 and the second frame F2, the object tracking module 135 may define the position 40 of the first object X1 in the first frame F1 by using a bounding box B1. Then, the object tracking module 135 may track positions of the first object X1 in the remaining four frames in a forward direction by adopting various conventional video object tracking technologies. Each of the estimated positions of the first object X1 in the remaining four frames is represented by a bounding box B2. Examples of the conventional video object tracking technologies include but are not limited to: a mean shift algorithm, a continuously adaptive mean shift algorithm, an ensemble tracking algorithm, and the like.

The object tracking module 135 may also calculate a weight value for the estimated position of the first object X1 in each frame. For example, the weight values for the positions of the first object X1 in the respective frames may be 1, 0.75, 0.5, 0.25 and 0 in sequence. A higher weight value indicates that the first object X1 is covered by the bounding boxes B1, B2 more completely, and the estimated position of the first object X1 in the corresponding frame is more precise.

Similarly, the object tracking module 135 may define the position 42 of the first object X1 in the second frame F2 by using the bounding box B1. Then, the object tracking module 135 may track positions of the first object X1 in the remaining four frames in a reverse direction by adopting various conventional video object tracking technologies. Each of the estimated positions of the first object X1 in the remaining four frames is also represented by the bounding box B2. Likewise, the object tracking module 135 may calculate a weight value for the estimated position of the first object X1 in each frame. For example, the weight values for the positions of the first object X1 in the respective frames may be 0, 0.25, 0.5, 0.75 and 1 in sequence.

Finally, a weighted average calculation is performed on the weight values calculated for the positions of the first object X1 in the respective frames in cases of the forward direction tracking and the reverse direction tracking so as to determine the position of the first object X1 in each frame. Thereby, the motion trajectory of the first object X1 from the first frame F1 to the second frame F2 can be estimated. The motion trajectories of the second object X2 and the third object X3 can be estimated in the same way.

In other embodiments, the object tracking module 135 may also determine the position of the first object X1 in each frame appearing between the first frame F1 and the second frame F2 according to the positions 40, 42 of the first object X1 in the first frame F1 and the second frame F2 by adopting various conventional interpolation algorithms so as to estimate the motion trajectory of the first object X1 from the first frame F1 to the second frame F2.

A second embodiment of the present invention is a video object tracking method for use in an electronic device. The electronic device of this embodiment may comprise a video providing unit and a processing unit electrically connected to each other. The processing unit may comprise a video splitting module, an object defining module and an object tracking module. The video object tracking method of this embodiment is adapted for the electronic device 1 of the first embodiment.

The video object tracking method of this embodiment can be implemented by a computer program product. When the computer program product is loaded into an electronic device and a plurality of codes comprised in the computer program product is executed, the video object tracking method of this embodiment can be accomplished. The aforesaid computer program product may be stored in a tangible computer-readable medium, such as a read only memory (ROM), a flash memory, a floppy disk, a hard disk, a compact disk, a mobile disk, a magnetic tape, a database accessible to networks, or any other storage media with the same function and well known to those skilled in the art.

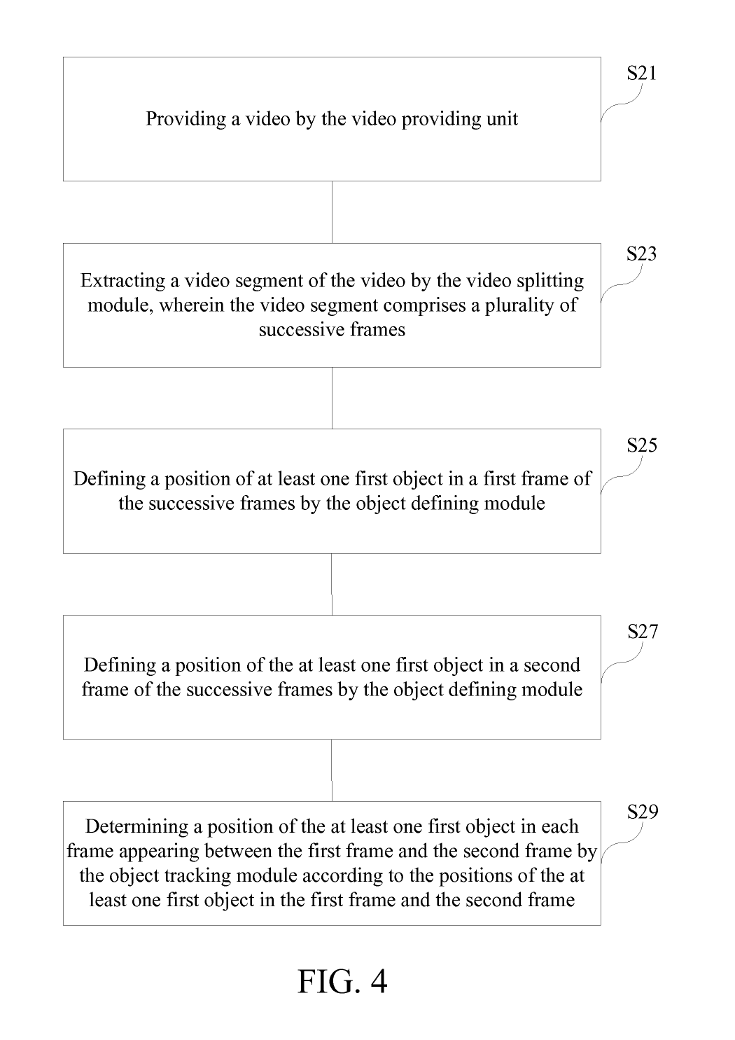

FIG. 4 is a schematic view of the video object tracking method according to this embodiment. The video object tracking method of this embodiment comprises steps S21, S23, S25, S27 and S29, but the order of these steps is not intended to limit the present invention.

As shown in FIG. 4, in the step S21, a video is provided by the video providing unit. In the step S23, a video segment of the video is extracted by the video splitting module. The video segment comprises a plurality of successive frames. In the step S25, a position of at least one first object is defined by the object defining module in a first frame of the successive frames. In the step S27, a position of the at least one first object is defined by the object defining module in a second frame of the successive frames. Optionally, the first frame is the start frame of the successive frames, and the second frame is the end frame of the successive frames. In the step S29, a position of the at least one first object in each frame appearing between the first frame and the second frame is determined by the object tracking module according to the positions of the at least one first object in the first frame and the second frame.

In other embodiments, the electronic device may further comprise a user interface unit electrically connected to the processing unit, and the object defining module defines the positions of the at least one first object in the first frame and the second frame according to a user input from the user interface unit.

In other embodiments, the video object tracking method of this embodiment may further comprise the following steps of: defining a position of at least one second object in the second frame by the object defining module; defining a position of the at least one second object in a third frame of the successive frames by the object defining module, wherein the third frame is between the first frame and the second frame; and determining a position of the at least one second object in each frame appearing between the second frame and the third frame by the object tracking module according to the positions of the at least one second object in the second frame and the third frame.

In other embodiments, the video object tracking method of this embodiment may further comprise the following steps of: defining a position of at least one third object in the first frame by the object defining module; defining a position of the at least one third object in a third frame of the successive frames by the object defining module, wherein the third frame is between the first frame and the second frame; and determining a position of the at least one third object in each frame appearing between the first frame and the third frame by the object tracking module according to the positions of the at least one third object in the first frame and the third frame.

In other embodiments, the video object tracking method of this embodiment may further comprise the following steps of: determining a plurality of particular frames between the first frame and the second frame by the object defining module; defining a position of a same object in each of two adjacent frames, wherein the two adjacent frames are from the first frame, the second frame and the particular frames; and determining a position of the same object in each frame appearing between the two adjacent frames by the object tracking module according to the positions of the same object in the two adjacent frames.

In addition to the aforesaid steps, the video object tracking method of this embodiment can also execute all the operations and functions set forth with respect to the electronic device 1 of the first embodiment. Steps undisclosed in this embodiment can be readily appreciated by those of ordinary skill in the art based on the explanation of the first embodiment, and thus will not be further described herein.

According to the above descriptions, the present invention provides an electronic device and a video object tracking method thereof. With the aforesaid operations of the video providing unit and the processing unit, the electronic device and the video object tracking method thereof select two frames from a plurality of successive frames comprised in a video segment and define positions of one or more same objects in the two frames respectively. Then, a position of the one or more same objects in each frame appearing between the two frames is determined according to the positions of the one or more same objects in the two frames so as to estimate a motion trajectory of the one or more same objects between the two frames. Different from conventional manual video object tracking methods which have to estimate the motion trajectories of different objects one by one, the present invention can estimate motion trajectories of multiple objects synchronously. Therefore, the time that conventional manual video object tracking technologies take in tracking a plurality of objects can be effectively reduced.

The above disclosure is related to the detailed technical contents and inventive features thereof. Persons skilled in this art may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An electronic device, comprising:
a video providing unit, being configured to provide a video; and
a processing unit electrically connected to the video providing unit, comprising:
a video splitting module, being configured to extract a video segment of the video, wherein the video segment comprises a plurality of successive frames;
an object defining module, being configured to define a position of at least one first object in a first frame of the successive frames and define a position of the at least one first object in a second frame of the successive frames; and
an object tracking module, being configured to determine a position of the at least one first object in each frame appearing between the first frame and the second frame according to the positions of the at least one first object in the first frame and the second frame.

2. The electronic device as claimed in claim 1, wherein:
the object defining module is further configured to:
define a position of at least one second object in the second frame; and
define a position of the at least one second object in a third frame of the successive frames, wherein the third frame is between the first frame and the second frame; and
the object tracking module is further configured to:
determine a position of the at least one second object in each frame appearing between the second frame and the third frame according to the positions of the at least one second object in the second frame and the third frame.

3. The electronic device as claimed in claim 1, wherein:
the object defining module is further configured to:
define a position of at least one third object in the first frame; and
define a position of the at least one third object in a third frame of the successive frames, wherein the third frame is between the first frame and the second frame; and
the object tracking module is further configured to:
determine a position of the at least one third object in each frame appearing between the first frame and the third frame according to the positions of the at least one third object in the first frame and the third frame.

4. The electronic device as claimed in claim 1, wherein the first frame is the start frame of the successive frames, and the second frame is the end frame of the successive frames.

5. The electronic device as claimed in claim 1, further comprising a user interface unit electrically connected to the processing unit, wherein the object defining module defines the positions of the at least one first object in the first frame and the second frame according to a user input from the user interface unit.

6. The electronic device as claimed in claim 1, wherein:
the object defining module is further configured to:
determine a plurality of particular frames between the first frame and the second frame; and
define a position of a same object in each of two adjacent frames, the two adjacent frames are from the first frame, the second frame and the particular frames; and
the object tracking module is further configured to:
determine a position of the same object in each frame appearing between the two adjacent frames according to the positions of the same object in the two adjacent frames.

7. A video object tracking method for use in an electronic device, the electronic device comprising a video providing unit and a processing unit electrically connected to each other, the processing unit comprising a video splitting module, an object defining module and an object tracking module, and the video object tracking method comprising the steps of:
(a) providing a video by the video providing unit;
(b) extracting a video segment of the video by the video splitting module, wherein the video segment comprises a plurality of successive frames;
(c) defining a position of at least one first object in a first frame of the successive frames by the object defining module;
(d) defining a position of the at least one first object in a second frame of the successive frames by the object defining module; and
(e) determining a position of the at least one first object in each frame appearing between the first frame and the second frame by the object tracking module according to the positions of the at least one first object in the first frame and the second frame.

8. The video object tracking method as claimed in claim 7, further comprising the steps of:
(f1) defining a position of at least one second object in the second frame by the object defining module;
(f2) defining a position of the at least one second object in a third frame of the successive frames by the object defining module, wherein the third frame is between the first frame and the second frame; and
(f3) determining a position of the at least one second object in each frame appearing between the second frame and the third frame by the object tracking module according to the positions of the at least one second object in the second frame and the third frame.

9. The video object tracking method as claimed in claim 7, further comprising the steps of:
(g1) defining a position of at least one third object in the first frame by the object defining module;
(g2) defining a position of the at least one third object in a third frame of the successive frames by the object defining module, wherein the third frame is between the first frame and the second frame; and
(g3) determining a position of the at least one third object in each frame appearing between the first frame and the third frame by the object tracking module according to the positions of the at least one third object in the first frame and the third frame.

10. The video object tracking method as claimed in claim 7, wherein the first frame is the start frame of the successive frames, and the second frame is the end frame of the successive frames.

11. The video object tracking method as claimed in claim 7, wherein the electronic device further comprises a user interface unit electrically connected to the processing unit, and the object defining module defines the positions of the at least one first object in the first frame and the second frame according to a user input from the user interface unit.

12. The video object tracking method as claimed in claim 7, further comprising the steps of:
(h1) determining a plurality of particular frames between the first frame and the second frame by the object defining module;
(h2) defining a position of a same object in each of two adjacent frames, wherein the two adjacent frames are from the first frame, the second frame and the particular frames; and
(h3) determining a position of the same object in each frame appearing between the two adjacent frames by the object tracking module according to the positions of the same object in the two adjacent frames.
